(19) United States
(12) Patent Application Publication
(10) Pub. No.: US 2010/0274495 A1
(43) Pub. Date: Oct. 28, 2010

(54) NOVEL CLINICAL TRIAL METHODS TO IMPROVE DRUG DEVELOPMENT FOR DISEASE THERAPY AND PREVENTION

(76) Inventor: Robert Sobol, Rancho Santa Fe, CA (US)

Correspondence Address: PERKINS COIE LLP, POST OFFICE BOX 1208, SEATTLE, WA, 98111-1208, US

(21) Appl. No.: 12/714,973

(22) Filed: Mar. 1, 2010

Related U.S. Application Data
(60) Provisional application No. 61/156,302, filed on Feb. 27, 2009.
(60) Provisional application No. 61/158,240, filed on Mar. 6, 2009.
(60) Provisional application No. 61/160,623, filed on Mar. 16, 2009.
(60) Provisional application No. 61/178,422, filed on May 14, 2009.
(60) Provisional application No. 61/186,110, filed on Jun. 11, 2009.

(51) Int. Cl. G06F 19/00

(52) U.S. Cl. 702/19

(57) ABSTRACT

In one embodiment, a method for a multiplexed continuous biomarker clinical trial is disclosed that evaluates multiple drugs concurrently or subsequently against a continuously collected and enlarging control group with increasing statistical power.

### CROSS-REFERENCE TO RELATED APPLICATIONS

This application claims the benefit of: U.S. Provisional Patent Application No. 61/156,302, filed Feb. 27, 2009; U.S. Provisional Patent Application No. 61/158,240, filed Mar. 6, 2009; U.S. Provisional Patent Application No. 61/160,623, filed Mar. 16, 2009; U.S. Provisional Patent Application No. 61/178,422, filed May 14, 2009; U.S. Provisional Patent Application No. 61/186,110, filed Jun. 11, 2009, all of which are incorporated herein by reference.

### FIELD OF THE INVENTION

The present invention relates generally to the fields of clinical trials and biomarkers predictive of therapy efficacy.

### DESCRIPTION OF RELATED ART

The development of cancer therapies is currently a very lengthy and costly process. It is estimated that approximately 8-10 years and over $500 million is required to develop a new drug. Christopher P. Adams and Van V. Brantner, Estimating the Cost of New Drug Development: Is it Really $802 Million?, Health Affairs, vol. 25, no. 2 at 420-28 (2006).

Approximately 8 million people die from cancer each year worldwide with over 500,000 deaths annually in the United States. World Health Organization, Cancer, http://www.who.int/cancer/en/(last visited Feb. 27, 2009). Hence, during the period of a new cancer drug's development, approximately 64 to 80 million people will die without the potential benefit of that therapy.

Hence, there is a clear need to find novel clinical trial design strategies to decrease the time and expense required to develop new cancer treatments and preventions.

The American Society of Clinical Oncology has provided a summary of the typical steps involved in cancer drug development as follows:

Preclinical Research

Before a new therapy can be given to patients, the underlying research hypothesis (the explanation for how the new therapy works) must be proven under controlled, artificial circumstances in a laboratory environment. This stage is called preclinical research, and it can take years to turn this knowledge into a new therapy.

If preclinical research proves successful, the sponsor of the trial files an Investigational New Drug (IND) application with the U.S. Food and Drug Administration (FDA) requesting permission to begin trials in humans. If the IND application is approved, researchers can begin to investigate the new therapy, which includes an array of studies to determine whether there is enough evidence to support advancement to the next phase of investigation.

Phase I Clinical Trials

The goal of a phase I clinical trial is to prove that a new drug or treatment, which has proven to be safe for use in animals, also may be given safely to humans. Doctors collect data on the dose, timing, and safety of the investigational therapy. People who participate in phase I clinical trials are often the first to receive a new therapy or a new combination of therapies.

In phase I clinical trials, the dose of an investigational drug is gradually increased to determine the optimal safe dose. This process is called dose escalation. The first participants are given a small dose of the drug. If there are no or few side effects, the next group is given higher amounts of the drug until the doctors determine the optimal dose with the fewest side effects. The doctors also learn the best way to administer the new treatment, such as by mouth or through a vein. Finally, the doctors collect data on how the drug is absorbed, processed, and spread through the body.

Phase I clinical trials generally last several months to a year and involve a very small number of people, usually no more than 10 to 20. People whose cancers have not responded to prior chemotherapy are often offered participation in phase I clinical trials. However, phase I clinical trials do not test how well a drug works. Sometimes, a person's cancer will respond to investigational drugs in this phase, but this situation is rare.

Phase II Clinical Trials

Phase II clinical trials are designed to provide more detailed information about the safety of the treatment, as well as to evaluate the efficacy of the drug. These trials focus on determining whether the new treatment has an anticancer effect in a specific cancer such as shrinking a tumor or improving blood test results. Phase II clinical trials take about two years to complete and usually involve about 20 to 40 people. The response rate in this phase needs to be equal to or higher than the standard treatment in order to proceed to phase III clinical trials.

Phase III Clinical Trials

The goal of phase III clinical trials is to take a new treatment that has shown promising results when used to treat a small number of patients with a particular disease and compare it with the current standard of care for that specific disease. In this phase, data are gathered from large numbers of patients to determine whether the new treatment is more effective and possibly less toxic than the current standard treatment. Phase III clinical trials are usually randomized, meaning that patients are assigned treatment groups in a non-ordered way. Although phase III trials focus on patients with a specific disease, they typically include patients of various ages, multiple ethnicities, and both genders so that the results, once obtained, may be applicable to a large number of people. The number of people enrolled in a phase III clinical trial can range in the hundreds to thousands and take many years to complete. Cancer.Net, Phases of Clinical Trials, http://www.cancer.net/patient/Diagnosis+and +Treatment/Treating+Cancer/Clinical+Trials/Phases+of+Clinical+Trials (last visited Feb. 27, 2009).

In the current drug development process, these clinical development phases are performed sequentially taking approximately 8-10 years to complete. Typically, a single novel treatment or treatment regimen is compared against the standard of care therapy which serves as the control in clinical trials designed to demonstrate the safety and efficacy of the new treatments. It should also be noted, that many candidate cancer therapies never demonstrate an improvement over previous treatments and they do not gain regulatory approval.

Biomarker Profiles Predictive of Treatment Efficacy and Resistance

On the positive side, recent advances in genomics technologies provide an unprecedented ability to identify biomarkers of oncology drug efficacy and resistance. These powerful techniques may be employed to improve the selection of candidate drugs for development and to increase the success rate of pivotal clinical trials by incorporating predictive efficacy and resistance biomarkers. Examples of these genomics techniques are well known in the art and include gene expression profiling, gene sequencing, gene copy number, single nucleotide polymorphisms genotyping, comparative genome hybridization, microRNA profiles, gene promoter/regulation profiles, DNA methylation studies, low-multiplex analysis of DNA, RNA, and protein and related microarrays. See, e.g., Illumina, http://www.illumina.com/pages.ilmn?ID=176 and Affymetrix, http://www.affymetrix.com/index.affx and Agilent, http://www.chem.agilent.com.

In high throughput sequencing methods, spatially separated, clonally amplified DNA templates or single DNA molecules are sequenced in a flow cell in a massively parallel manner. Through iterative cycles of polymerase-mediated nucleotide extensions or through successive oligonucleotide ligations and related methods, sequence outputs in the range of hundreds of megabases to gigabases are now obtained routinely. In addition, real-time single-molecule DNA sequencing and nanopore-based sequencing methods may also be applied for biomarker determinations. See, e.g., Voelkerding K V et al., Next-Generation Sequencing: From Basic Research to Diagnostics Clin Chem. 2009 Feb 26. [Epub ahead of print] and Marioni J C et al., RNA-seq: An assessment of technical reproducibility and comparison with gene expression arrays. Genome Res. 2008 Sep. 18 (9): 1509-1517. The information obtained from high throughput sequencing data enables identification of differentially expressed genes, while allowing for additional analyses such as detection of low-expressed genes, alternative splice variants, and novel transcripts. The Illumina/Solexa technology requires only 1 ug of DNA per library, enabling the study of primary tumour DNA that may not be available in large quantities See, e.g., Illumina, http://www.illumina.com/pages.ilmn?ID=176.

Similarly, proteomics technologies may also be applied to determine profiles of expressed proteins associated with treatment efficacy and resistance. See, e.g. Ma Y et al, Predicting cancer drug response by proteomic profiling. Clin Cancer Res. 2006 Aug. 1; 12(15):4583-9; Ma Y et al, An integrative genomic and proteomic approach to chemosensitivity prediction. Int J Oncol. 2009 January; 34(1):107-15. These predictive biomarker profiles of treatment efficacy and resistance permit identification of the patients most likely to benefit from a specific therapy that have tumors or normal tissues bearing the specific biomarker profile associated with treatment benefit and/or the absence of resistance. While these techniques increase the success rate of clinical trials by selecting for enrollment of patients bearing favorable efficacy biomarker profiles, they do not significantly decrease the time required for drug approval because in the current art these biomarker directed trials are still performed in the sequential Phase I, II, III trial design algorithm that results in lengthy and costly clinical development. In addition, current pivotal clinical trial designs typically incorporate a limited number of predefined predictive efficacy biomarkers that do not always predict treatment outcomes as expected.

### SUMMARY

According to one embodiment of the present invention, there is provided a more effective method of drug development termed “multiplexed, continuous biomarker directed clinical trials” which reduces drug development times and costs by employing simultaneous testing of billions of biomarker profiles for multiple treatments against a standard of care control therapy in a parallel continuous fashion rather than in the conventional serial sequential manner employing a limited number of pre-defined biomarkers. One element of this method is that the clinical trials are performed continuously and that they do not end in the traditional way when the efficacy or failures of test drugs are determined. Another element is the concurrent testing of patients for billions of potential predictive biomarkers rather than the conventional approach for testing a limited number of pre-defined biomarkers in pivotal clinical trials. In addition, accrual to the standard of care control arm is continued for use in comparative testing against multiple additional new drugs in parallel as they are developed. The large numbers of biomarkers tested combined with the large size of the previous and continuously accrued control arm provides significant statistical power for comparisons with multiple test drugs increasing the success rate of clinical trials by improving the ability to identify patients that are most likely to benefit from a specific treatment. The invention also permits more rapid assessment of test drugs' efficacy by permitting enrollment of the test drug treated patients at a higher rate compared to the control arm treatment population that is already sufficiently accrued. Furthermore, successful demonstration of the efficacy of a new therapy for a particular biomarker defined population becomes de facto the new standard of care for these patients which in turn will serve as the new standard of care control arm to test newer therapies by the same novel multiplexed continuous clinical trials methodology.

The overall effects of these methods are the ability to identify a larger number of effective new drugs in a shorter period of time at reduced costs permitting more rapid availability of new treatments for cancer patients who otherwise would have died before the treatments' efficacies were demonstrated and made available for patients care.

### BRIEF DESCRIPTION OF THE DRAWINGS

FIG. 1—Multiplexed and Continuous Biomarker Clinical Trial. The approach depicted for Drugs #1-3 in FIG. 1 may be employed for multiple different drugs tested in a parallel overlapping manner for any experimental drug “Xₙ” with a predictive efficacy biomarker profile “Yₙ” similarly tested against the control group of patients that have the same predictive biomarker profile “Yₙ” but are treated with the standard of care without experimental drug “Xₙ” where X=any new drug for the treatment of that same cancer type and Y=the specific biomarker efficacy profile predicting the efficacy of treatment “X” in that specific cancer type.

FIG. 2—Tandem Performance of Multiple Paired Independent Multiplexed Continuous Biomarker Clinical Trials. The approach depicted in FIG. 2 is accomplished by separate accrual of patients and independent data analyses from two paired but distinct groups of identically treated patients generally from different clinical trial sites with no overlapping patient between the two data sets. An interim data analysis from the two paired distinct data sets is compared. For instances like Drug #1 where the originally identified candidate predictive biomarkers are providing positive concordant biomarker efficacy results for Groups 1 and 2, such drug-predictive biomarker profiles are either considered for regulatory approval at that point in time or after accrual of additional patients with the same biomarker profiles if required to demonstrate statistically significant clinical improvement compared to the control standard treatment. For instances like Drug #2, evaluation of drug-predictive biomarker profiles is stopped when the interim analyses of Groups 3 and 4 do not provide concordant biomarker efficacy results for both groups of patients (e.g. Biomarker B). The data from both Groups 3 and 4 are then analyzed to identify new concordant biomarker profiles predictive of drug efficacy in both groups of patients (e.g. Biomarker C). Clinical testing of Drug #2 continues with additional patients in each group with the newly identified biomarker profile “C” to demonstrate statistically significant increases in treatment benefit compared to the control standard treatment for those biomarker defined patients in both patient groups. This process may be applied iteratively until a biomarker profile predictive of clinical efficacy compared to the control in both groups of patients is demonstrated with statistical significance.

FIG. 3—Gene Expression Biomarker Profiles Predictive of Drug Efficacy. Panels A, B and C show gene expression biomarker profiles identified by tiling microarrays that are predictive for the efficacy and resistance of breast cancer to Ixabepilone therapy. Ixabepilone has a genomic 10 gene expression profile predictive of therapeutic efficacy in breast cancer patients. Reproduced from Jose Baselga et al., Phase IIl Genomics Study of Ixabepilone as Neoadjuvant Treatment for Breast Cancer, J. Clin. Oncol., Vol. 27, No. 4 at 526-34 (Feb. 1, 2009), (Epub Dec. 15, 2008).

FIG. 4—Measurement of Gene Expression Biomarkers by High Throughput Whole Transcriptome Shotgun Sequencing (WTSS) and Exon tiling arrays. Predictive gene expression biomarker profiles may be identified by either tiling arrays or by high throughput sequencing methods. Panel A provides a scatter plot comparing the abundance of exons within all ENCODE regions as measured by Affymetrix tiling array (x-axis) and high throughput WTSS sequence coverage (y-axis). An example is shown (B) to illustrate the correspondence between exon signal from array (black) and sequence data (blue). Reproduced from Ryan D. Morin et al., Profiling the HeLa S3 transcriptome using randomly primed cDNA and massively parallel short-read sequencing. BioTechniques 2008 45:81-94.

FIG. 5—High Throughput Sequencing Identifies Alternative Splicing Biomarkers by Exon Junction-Spanning Reads in Cervical Carcinoma. Additional predictive biomarkers are identified by high throughput sequencing analysis of exon junction-spanning reads. Shown are two examples of unannotated splicing events. The first example (A) involves an exon skip in which the middle exon is not included (shown in black in the top track). The second example shows a known exon joined to a putative novel cryptic exon (B). The linkage of this exon to the intronic peak (upper right, blue) is supported by multiple exon junction-spanning reads (shown in black below the peaks). The later event involves a known tumor suppressor gene (Bin1), which is known to produce many distinct isoforms. Reproduced from Ryan D. Morin et al., Profiling the HeLa S3 transcriptome using randomly primed cDNA and massively parallel short-read sequencing, BioTechniques 2008 45:81-94.

FIG. 6—High Throughput Sequencing Detection of Human Papilloma Virus (HPV) Biomarker in Cervical Carcinoma. High throughput sequencing may also be utilized to detect molecular biomarkers of viral infections associated with different types of cancers. The panels below depict widespread transcription near the HPV18 integration site. This region of chromosome 8 (128,290,875-128,312,000) showed a large enrichment for peaks in both the polyA- and polyA+fractions. This is a known fragile site and a preferred integration site for the HPV18 genome. The clone mapped to this region (BC106081) was obtained from an unknown cervical cancer cell specimen. The clone is flagged as “chimeric” and includes a portion of the HPV genome, suggesting it results from similar transcription of this region in that tumor cell specimen. Reproduced from Ryan D. Morin et al., Profiling the HeLa S3 transcriptome using randomly primed cDNA and massively parallel short-read sequencing. BioTechniques 2008 45:81-94.

FIG. 7—High Throughput Sequencing (HTS) Detection of Genomic Rearrangement Biomarkers in Breast Cancer. High throughput sequencing is also utilized to identify gene rearrangement biomarkers. The upper diagrams show wild-type structures and the lower diagrams show the rearranged structure. Red thick arrows are chimeric cDNAs captured by HTS reads. (A) Translocation between chromosomes 9 and 18 created an in-frame chimeric product proposed to be composed of 120 aa from 5′ terminus of PDCD1 LG2 and 172 aa from 3′ terminus of C18orf10. (B) Transcription of the chimeric transcript involving NSD1 continued for another 134 by on chromosome 8 before poly(A) tail was added to the mRNA. Translation of the chimeric protein contained 1,265 aa from the 5′ end of NSD1 plus 19 aa from the intergenic region on chromosome 8 before stopped by an in-frame stop codon marked by an asterisk. (C) An genomic fragment was flipped as shown by the orange arrow. The PHF20L1 gene is truncated by a stop codon marked by an asterisk. Reproduced from Zhao Q. et al., Transcriptome-guided characterization of genomic rearrangements in a breast cancer cell line. Proc Natl Acad Sci U S A. 2009 Feb 10; 106(6):1886-91. Epub 2009 Jan. 30.

FIG. 8—High Throughput Sequencing (HTS) Detection of Somatic Mutation. Biomarkers in Acute Myelogenous Leukemia (AML). High throughput sequencing is also utilized to identify somatic mutation biomarkers. The left panel depicts the algorithm followed to confirm somatic mutations in tumor from an AML patient by analysis of the patient's tumor, normal skin and database normal genomes. The right panel demonstrates the statistically significant difference in the abundance of the mutations found in primary tumor, relapsed tumor and normal skin. Low levels of mutated sequences were detected in normal skin due to the presence of leukemic tumor cells in the blood vessels of normal skin tissues. Reproduced from Ley T J et al., DNA sequencing of a cytogenetically normal acute myeloid leukaemia genome. Nature (2008) 456:66-72.

FIG. 9—High Throughput Sequencing (HTS) Single Nucleotide Polymorphisms (SNP) Genotyping Biomarkers in Normal Skin and Tumor from an AML Patient. High throughput sequencing is also utilized to identify SNP biomarkers. Panel A is a Venn diagram of the overlap between SNPs detected by HTS in patient 933124's tumour genome and the genomes of J. D. Watson and J. C. Venter. Panel B is a Venn diagram of the overlap among 933124's tumour genome, the patient's skin genome and a SNP database dbSNP (ver. 127). Reproduced from Ley T J et al., DNA sequencing of a cytogenetically normal acute myeloid leukaemia genome. Nature (2008) 456:66-72.

FIG. 10—SNP Genotyping of Cytochrome p450—CYP2C19 Biomarker of Clopidogrel Pharmacokinetics, Pharmacodynamics and Resistance. An example of a molecular biomarker predictive of resistance to a cardiovascular drug is depicted. The left panel shows the effects associated with carriage of at least one reduced-function allele in five genes encoding cytochrome P-450 enzymes on the pharmacokinetic and pharmacodynamic responses to clopidogrel in 162 healthy subjects. The genetic effect on the pharmacokinetic response was measured as the relative percentage difference in the area under the plasma concentration-time curve from the time of administration to the last measurable concentration (AUCO-t), and the pharmacodynamic response was measured as the absolute difference in the reduction in maximal platelet aggregation ({Delta}MPA) in response to clopidogrel. The right panel demonstrates the association between status as a carrier of a CYP2C19 reduced-function allele and incidence of cardiovascular events or stent thrombosis in subjects receiving clopidogrel. Among 1459 subjects who were treated with clopidogrel and could be classified as CYP2C19 carriers or noncarriers, the rate of the primary efficacy outcome (a composite of death from cardiovascular causes, myocardial infarction, or stroke) was 12.1% among carriers, as compared with 8.0% among noncarriers (hazard ratio for carriers, 1.53; 95% CI, 1.07 to 2.19) (Right Panel Top). Among 1389 subjects treated with clopidogrel who underwent percutaneous angioplasty with stenting, the rate of definite or probable stent thrombosis was 2.6% among carriers and 0.8% among noncarriers (hazard ratio, 3.09; 95% CI, 1.19 to 8.00) (Right Panel Bottom). Reproduced from Mega J et al. Cytochrome p-450 polymorphisms and response to clopidogrel. N Engl J Med 2009; 360:354-362

FIG. 11—Chromosomal alterations detected before and after treatment of an ovarian tumor using human oligo comparative genomic hybridization (aCGH) microarray method as described by DeWitte A et al., 60-mer Oligo-Based Comparative Genomic Hybridization Application Note; http://www.chem.agilent.com/Library/applications/CGH_ApplicationNote_5989-4530EN_72dpi(RGB).pdf accessed Jun. 2, 2009.

FIG. 12—Tumor clonal responder genomics methods are summarized which include a) Isolating tumor clones by flow cytometry; b) Determining the genomics and proteomics biomarkers of the tumor clones; c) Categorization of tumor clones as treatment sensitive or resistant by assessments of apoptosis/senescence markers; clinical tumor response; time to progression; progression free survival; or overall survival; and d) Identifying biomarkers predictive of efficacy that are associated with tumor genomic clonotypes sensitive to treatment that are not associated with tumor genomic clonotypes resistant to that treatment.

### DETAILED DESCRIPTION

The following description is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

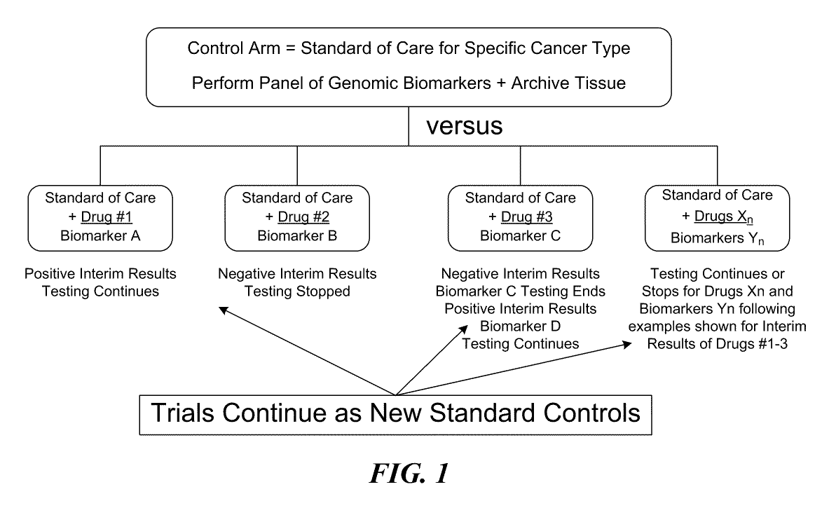

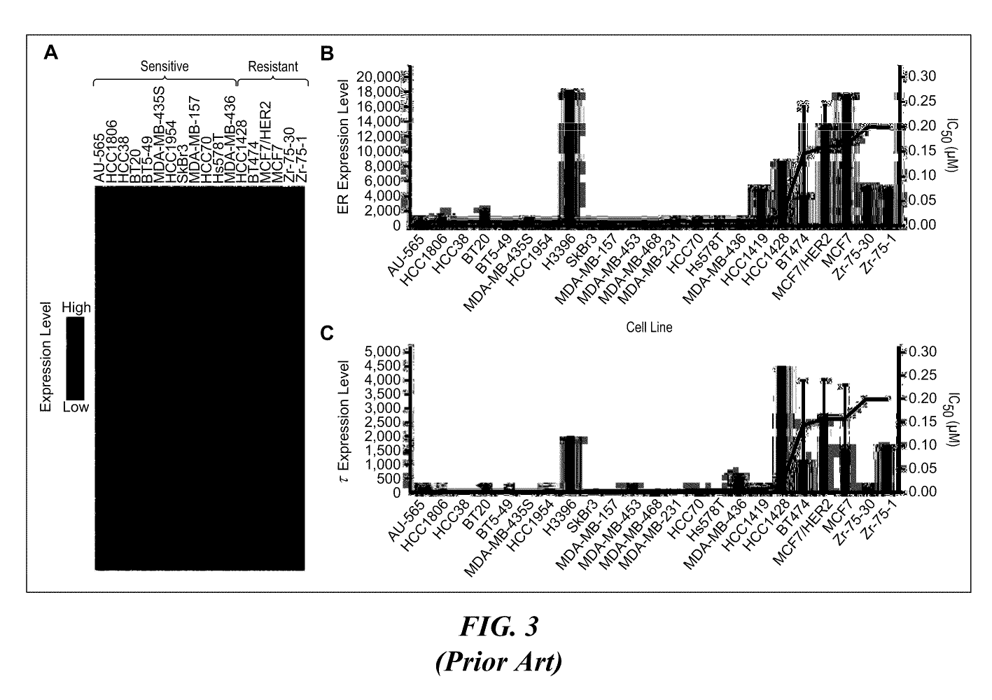

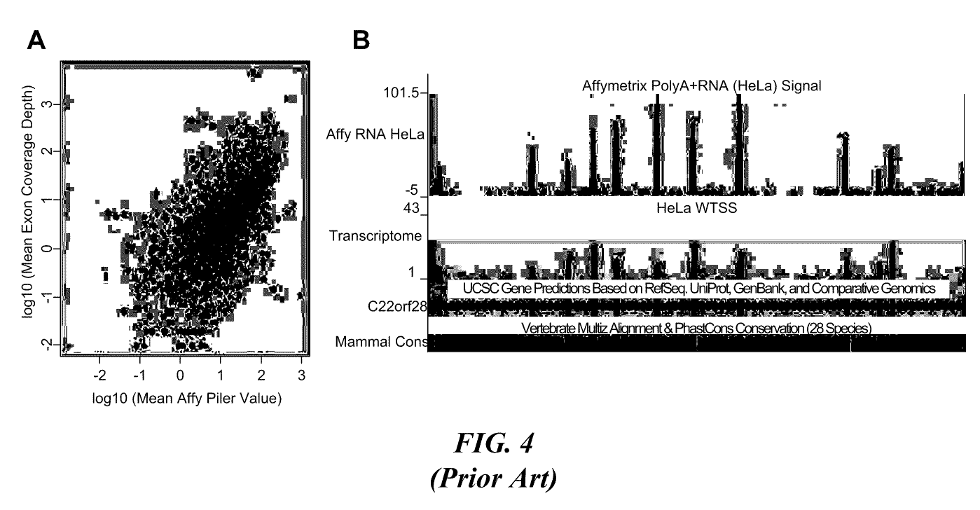

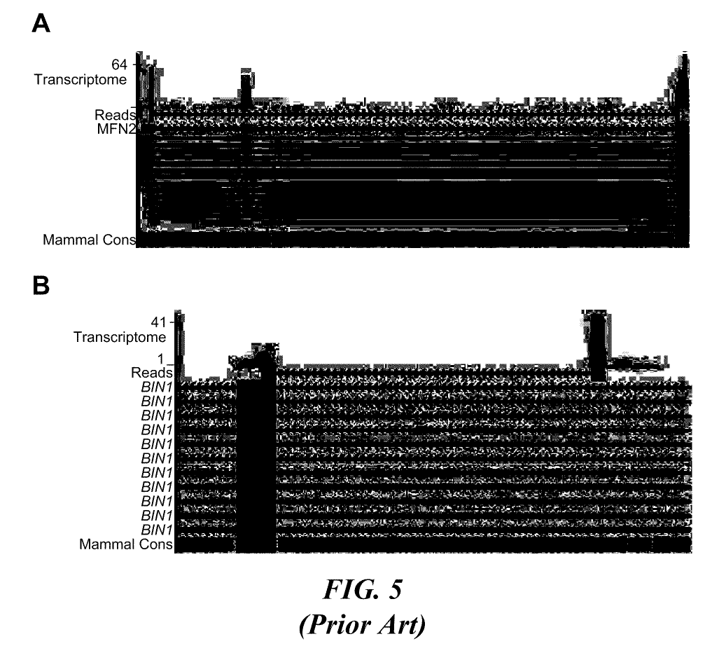

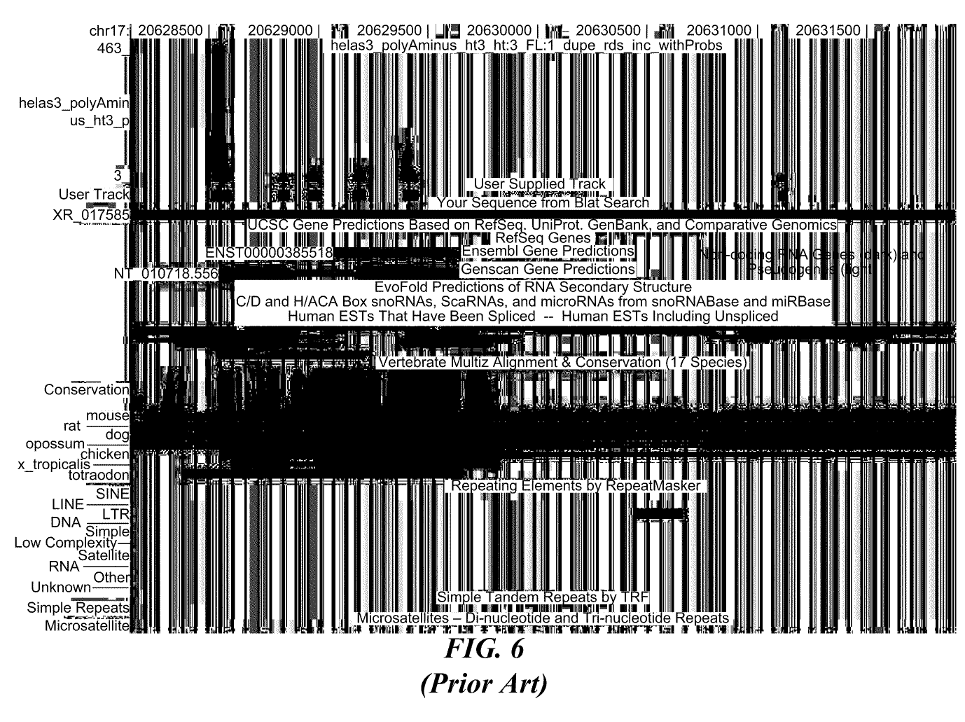

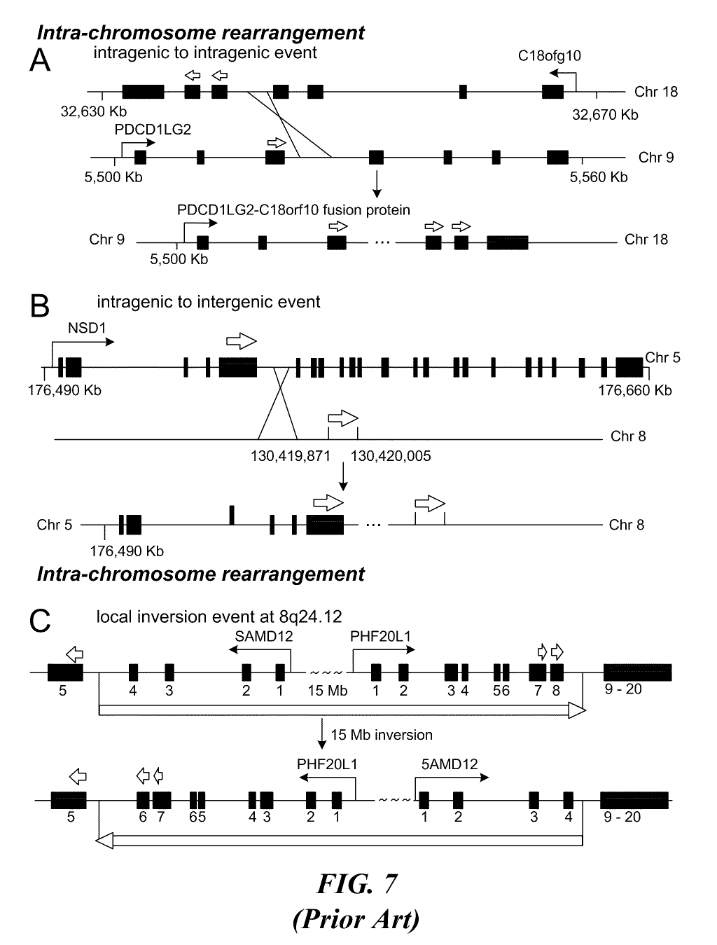

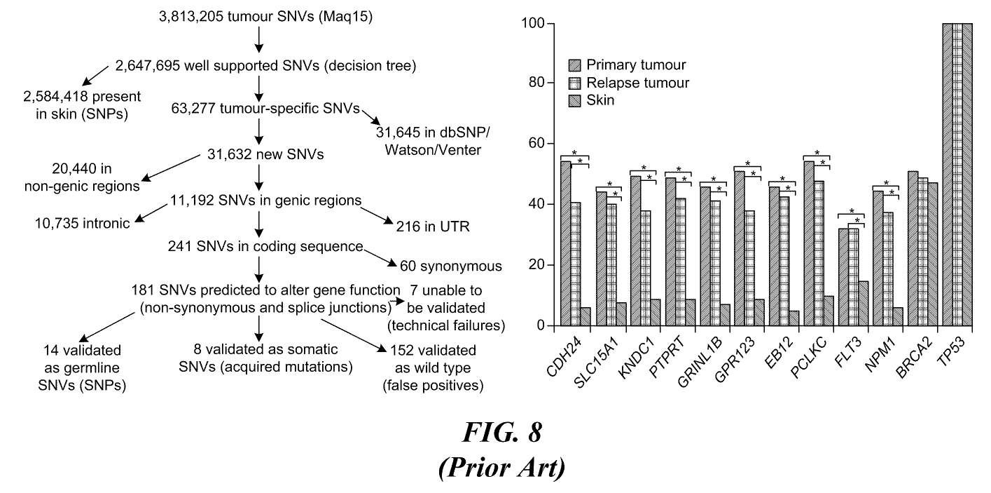

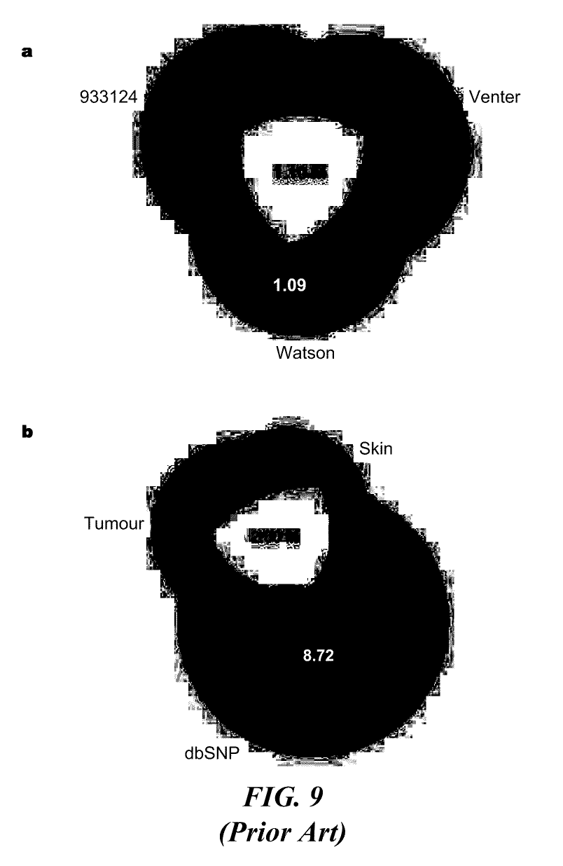

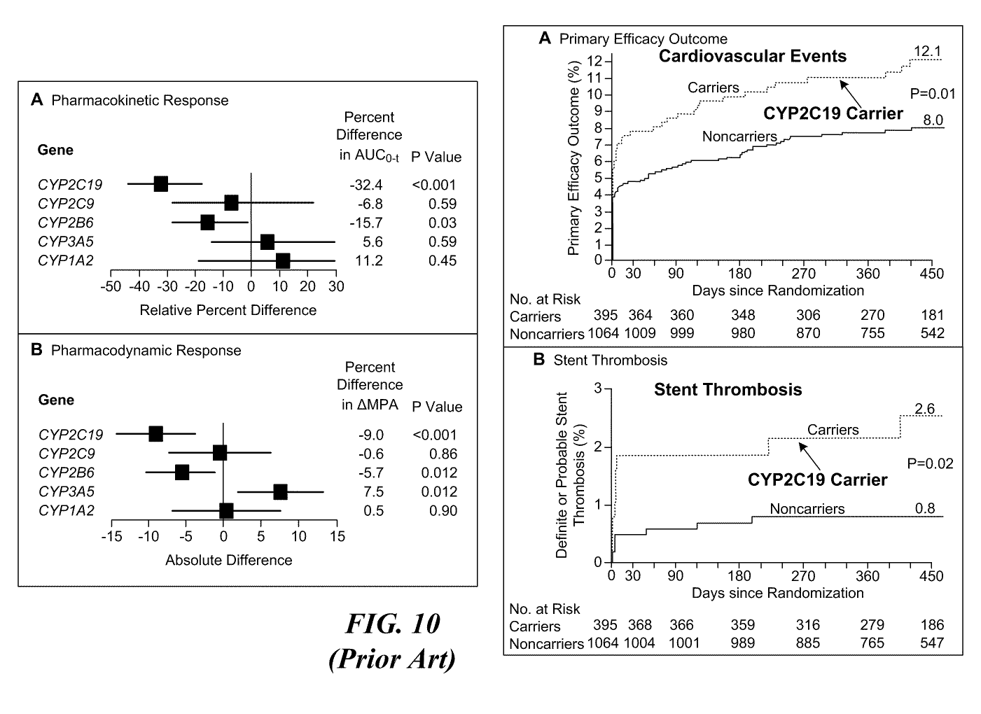

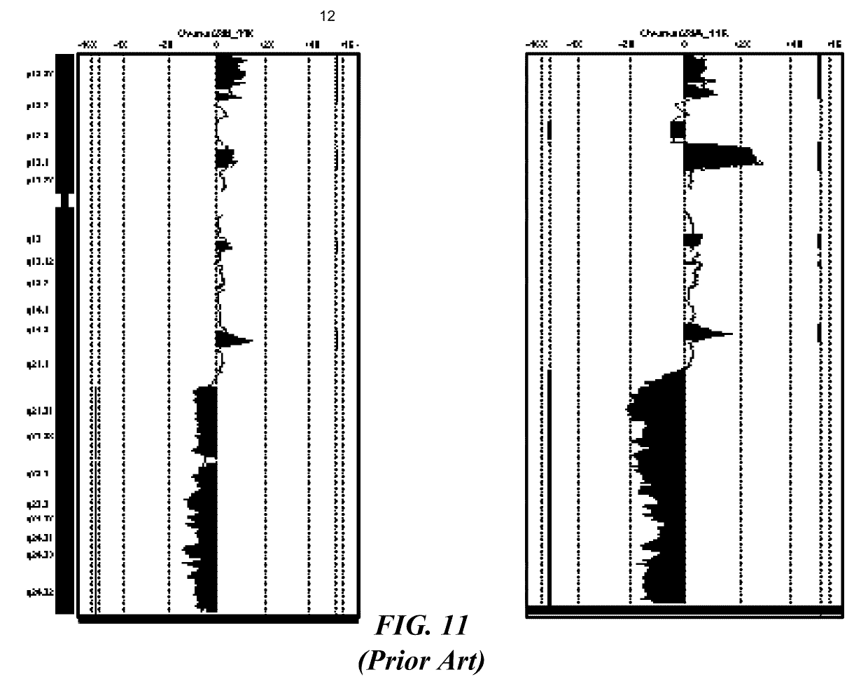

One embodiment for developing cancer therapies is illustrated in FIG. 1. The clinical trial is initiated by the enrollment of patients meeting the study's entry criteria who are treated with a standard of care therapy for their particular type of cancer. Tissue samples are obtained from these patients (typically tumor tissue and normal non-tumor tissue or peripheral blood) and tested for a panel of millions of biomarkers comprising billions of potential biomarker profile combinations, a subset of which may be predictive of the new drugs' treatment efficacy or resistance. Currently available biomarker testing methods using high throughput sequencing, gene chips and related microarray technologies are very powerful permitting the collection of literally billions of potential predictive biomarker profiles. See, e.g., FIGS. 3-11 and Voelkerding K V et al, Next-Generation Sequencing: From Basic Research to Diagnostics Clin Chem. 2009 Feb. 26. [Epub ahead of print], Illumina,http://www.illumina.com/pages.ilmn?ID=176 and Affymetrix, http://www.affymetrix.com/index.affx and Agilent http://www.chem.agilent.com/Library/applications/CGH_ApplicationNote_5989-4530EN_72dpi(RGB).pdf. These patient tissue samples should also be stored for potential future testing with additional biomarker technologies as they are developed. As new drug treatments become available for human efficacy testing, methods well known to those skilled in the art of genomics biomarkers are employed to define a candidate biomarker profile that is likely to predict the new drug's efficacy for the same type of cancer in the standard of care control treatment arm. See, e.g., FIGS. 3-11, Voelkerding K V et al, Next-Generation Sequencing: From Basic Research to Diagnostics Clin Chem. 2009 Feb 26. [Epub ahead of print], Illumina, http://www.illumina.com/pages.ilmn?ID=176; Affymetrix, http://www.affymetrix.com/index.affx and Jose Baselga et al., Phase II Genomics Study of lxabepilone as Neoadjuvant Treatment for Breast Cancer, J. Clin. Oncol., Vol. 27, No. 4 at 526-34 (Feb. 1, 2009), (Epub Dec. 15, 2008). Tissue samples (typically tumor and normal tissue or peripheral blood) are collected from these experimental treatment patients as well as from the control standard of care treatment patients and they are both tested for the initial candidate predictive biomarker and the same panels of billions of additional biomarker profiles a subset of which may also be predictive of treatment efficacy or resistance for the new drug. Patients with the initial candidate biomarker profile predictive of that treatments' efficacy and meeting the same study entry criteria are enrolled in the study and treated with the test therapy. The evaluation of multiple drugs may be performed in this fashion simultaneously as they become available for human clinical testing.

An example of a multiplexed continuous clinical trial is shown in FIG. 1. Experimental Drug #1 with a candidate predictive efficacy biomarker profile “A” is tested against the control group of patients that are found to have the same predictive biomarker profile “A” but are treated with the standard of care without experimental Drug #1. Concurrently or subsequently, when experimental Drug #2 with a candidate predictive efficacy biomarker profile “B” is ready for human efficacy testing, it is similarly tested against the control group of patients that are found to have the same predictive biomarker profile “B” but are treated with the standard of care without experimental Drug #2. Concurrently or subsequently, when experimental Drug #3 with a candidate predictive efficacy biomarker profile “C” is ready for human efficacy testing, it is similarly tested against the control group of patients that are found to have the same predictive biomarker profile “C” but are treated with the standard of care without experimental Drug #3.

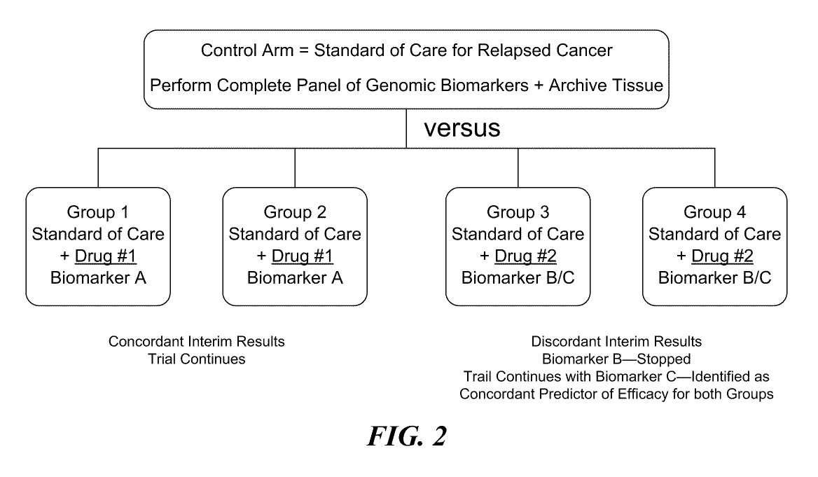

It should be noted that this approach may be utilized for the concurrent or subsequent testing in parallel of any number of experimental treatments “Xₙ” tested in a parallel fashion with each drug having a candidate predictive efficacy biomarker profile “Yₙ” similarly tested against the control group of patients that have the same predictive biomarker profile “Yₑ” but are treated with the standard of care without experimental drug “Xₙ” where X=any new treatment for that same cancer type as the control and Y=the specific biomarker efficacy profile predicting the efficacy of treatment “X” in that specific cancer type. In contrast to conventional clinical pivotal registration trials where patients may be tested for a restricted number of pre-defined biomarkers to support approvals, all patients in the new treatment and control treatment arms can be tested for billions of additional biomarker profiles as generally described in FIGS. 3-12. Additional biomarker examples beyond those shown in FIGS. 3-12 may be identified for use with the multiplexed continuous and/or tandem independent clinical trials described in FIGS. 1 and 2 respectively. The examples shown in FIGS. 1-12 for cancer and cardiovascular disease may also be applied for the development of treatment and prophylaxis for other disorders.

As demonstrated in FIG. 1, interim analyses are employed to guide further conduct of the trial. As depicted for Drug #1, when the interim analysis demonstrates positive efficacy results compared to standard treatment for patients with the initial candidate biomarker profile A, Drug#1 may be considered for regulatory approval at that point in time or after accrual of additional patients with biomarker profile A if required to demonstrate statistically significant differences in treatment outcome benefiting the patients treated with Drug #1 compared to the control standard treatment. When the interim analysis demonstrates negative efficacy results compared to standard treatment as shown for patients with biomarker profile B treated with Drug #2, the further evaluation of Drug #2 for patients with biomarker profile B is stopped. When the interim analysis demonstrates negative efficacy results compared to standard treatment as shown for patients with biomarker profile C treated with Drug #3, the further evaluation of Drug #3 for patients with biomarker profile C is stopped. However, when the interim analysis of the additional billions of biomarker profiles identifies a different biomarker profile D predictive of Drug #3 efficacy, the testing continues with additional patients with biomarker profile D to demonstrate statistically significant differences in treatment outcome benefiting the patients treated with Drug #3 compared to the control standard treatment in patients with biomarker profile D.

Furthermore, successful demonstration of the efficacy of a new therapy for a particular biomarker defined population becomes de facto the new standard of care for these patients which in turn will serve as the new standard of care control arm to test newer therapies by the same novel multiplexed continuous clinical trials methodology. The interim analysis approach depicted for three different drugs in FIG. 1 may be employed for multiple different drugs tested in a parallel overlapping manner for any experimental drugs “Xₙ” with predictive efficacy biomarker profiles “Yₙ” similarly tested against the control group of patients that have the same predictive biomarker profiles “Yₑ” but are treated with the standard of care without experimental drugs “Xₙ” where X=any new drug for that same cancer type and Y=the specific biomarker efficacy profile predicting the efficacy of treatment “X” in that specific cancer type.

The overall effects of these methods are the ability to identify a larger number of effective new drugs in a shorter period of time at reduced costs permitting more rapid availability of new treatments to cancer patients who otherwise would have died before the treatments' efficacy were demonstrated and made available for patient care. Thus, in the multiplexed continuous biomarker method of this embodiment, multiple drugs are tested concurrently or subsequently as they become available against a continuously collected control arm being treated with the standard of care for that particular cancer employing billions of biomarkers to identify the patients with efficacy predictive profiles who will benefit from a specific treatment.

Further, the clinical trials can be performed continuously and do not end in the traditional way when the efficacy or failures of test drugs are determined. Accrual to the standard of care control arm is continued for use in comparative testing against multiple additional new drugs in parallel as they are developed. The large numbers of biomarkers tested combined with the large size of the continuously accrued control arm provides significant statistical power for comparisons with multiple test drugs increasing the success rate of clinical trials by improving the ability to identify patients that are most likely to benefit from a specific treatment. Some embodiments also permit more rapid assessment of test drugs' efficacy by permitting enrollment of the test drug treated patients at a higher rate compared to the control arm treatment population that is already sufficiently accrued.

In addition, interim analyses can be used to redirect testing of the new drug in patients with different more predictive biomarker profiles of efficacy when the initial candidate biomarker profiles prove unsatisfactory.

In the above embodiment, the multiplexed continuous biomarker trial design permits the immediate initiation of a pivotal clinical trial for any drug simply by performing biomarker profile analyses on the patients' tissues and treating them with the current standard of care as the control. The power of the multiplexed continuous biomarker clinical trial accelerates drug development by starting pivotal control clinical trial data collection when drugs are in pre-clinical stages of development and even before new drugs are invented. Subsequently, treatment with the new drug and collection of these patients' biomarker data may be performed to complete the evaluation of that new drug more rapidly and cost effectively than with previous designs. Importantly, the multiplexed continuous biomarker trials will have an increased likelihood of success based upon their incorporation of biomarkers predictive of drug efficacy. Furthermore, the large size of the control patient populations accrued continuously in this method facilitate the demonstration of drug efficacy that might not be observed in traditional clinical trials that typically utilize smaller sized control populations.

Further in the above embodiment, the trial design is continuous. The efficacious treatment arms are continued when successful and de facto become the new standard of care and future control arms for new drug trials exploiting the same multiplexed continuous trial design advantages described herein. Another aspect of the present embodiment is illustrated in FIG. 2 where the multiplexed continuous trials are performed as two independent clinical studies in tandem to increase their statistical rigor and decrease the chances of false positive association of biomarker profiles with treatment efficacy that might occur by chance. This is accomplished by separate accrual of patients and independent data analyses from two different groups of identically treated patients. The accrual of patients for the two distinct data sets is from different clinical trial sites with no overlapping patient between the two data sets. An interim data analysis from the two distinct data sets is compared to increase the likelihood of a correct and successful result. When the initial candidate predictive biomarkers produce positive concordant interim results, these drug-predictive biomarker profiles may be considered for regulatory approval at that point in time or after accrual of additional patients with the same biomarker profiles if required to demonstrate statistically significant improvement in treatment outcomes benefiting the patients treated with these drugs compared to the control standard treatment. Evaluation of drug-predictive biomarker profiles is terminated for drugs when the interim analyses do not provide concordant biomarker results. The interim data from both groups is then analyzed to identify new concordant biomarker profiles predictive of drug efficacy in both groups of patients and the testing continues with additional patients in each group with the newly identified biomarker profile to demonstrate statistically significant increases in treatment outcomes benefiting the patients treated with the drug in those biomarker defined patients compared to the control standard treatment in both patient groups. This process may be applied iteratively until a biomarker profile predictive of efficacy in both groups of patients is demonstrated with statistical significance. Thus, conducting two independent clinical evaluations to obtain the same results in both groups of patients further confirms the validity of the identified biomarker profiles to predict drug efficacy. The performance of two independent clinical studies in tandem with interim analyses to refine biomarker efficacy selection as described above for multiplexed continuous biomarker clinical trials may also be applied to improve conventional clinical trial designs by increasing the likelihood of correct and successful biomarker efficacy results. It will also be appreciated by one skilled in the art that the method of the multiplexed continuous clinical trial may also be employed without biomarkers to improve drug development by permitting the efficiencies of multiple and continuous evaluation of experimental drugs in parallel compared to the conventional sequential serial process.

In another embodiment, the samples evaluated for biomarker analyses in the multiplexed continuous biomarker clinical trials and tandem independent biomarker clinical trials are obtained both before and after treatment is administered. In addition to the pre-treatment biomarker analyses described supra termed “static” pre-treatment biomarker analyses, the “dynamic” post-treatment biomarker analyses are similarly analyzed to identify profiles predictive of efficacy. Furthermore, the differences between the pre-treatment and post-treatment biomarkers are also determined and correlated with clinical outcomes to identify changes in biomarker profiles predictive of efficacy which are termed “differential” pretreatment and post treatment biomarker profiles predictive of efficacy.

It will also be apparent to those skilled in the art of clinical trials that the static, dynamic and differential biomarker profiles based upon molecular biomarkers may be complemented by combination with clinical biomarkers to improve the predictions of efficacy. This embodiment is termed combined molecular and clinical biomarker profiling predictive of efficacy. The statistical methods for assessing independent and dependent variables predictive of efficacy are well known in the art. See Peto R and Peto J, Asymptotically efficient rank invariate test procedures J R Stat Soc [A], 1972. 135: p. 185-206; and Cox D R, Regression models and lifetables, J R Stat Soc [B], 1972. 34 p. 187-220. These statistical methods are applied to analyze the combinations of clinical, static, dynamic, and differential molecular biomarkers.

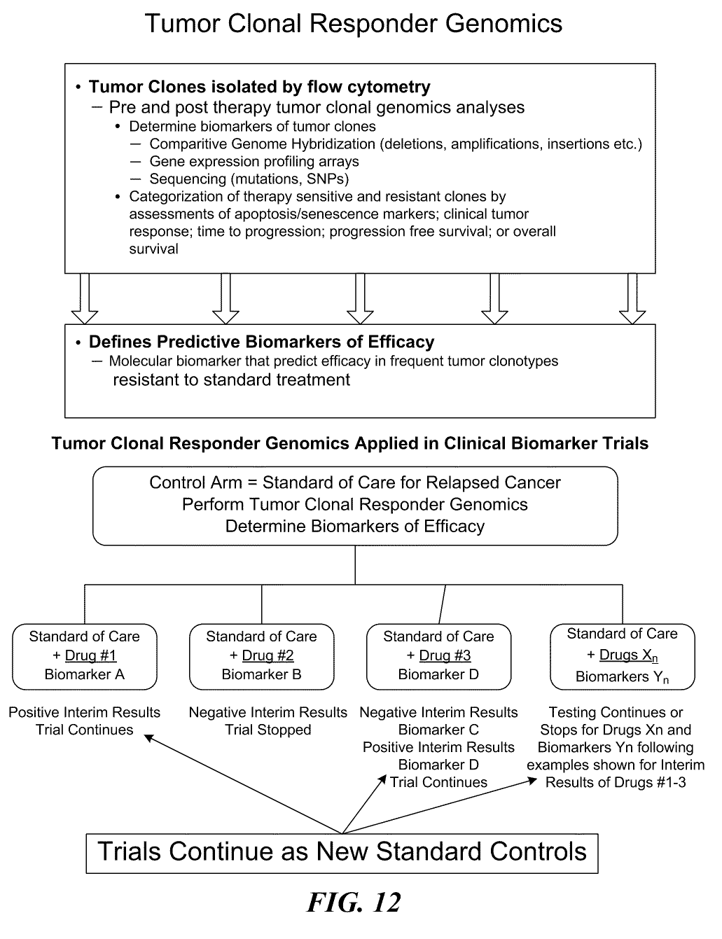

In another embodiment for developing cancer therapies, tumor samples are evaluated by methods termed clonal responder genomics to identify biomarkers predictive of treatment efficacy to improve clinical trial success. This approach is designed to provide significant improvements over the techniques known in the art for biomarker determination exemplified by the methods shown in FIGS. 3-11. Currently available methods may fail to identify important biomarkers due to confounding data introduced by the heterogeneous nature of tumor tissue samples that are known to contain a mixture of tumor cells and a wide variety of normal tissue cells. In addition, tumors are often heterogeneous being comprised of different tumor clones that may not be uniformly responsive to treatment. The method of clonal responder genomics permits the identification and evaluation of predictive efficacy biomarkers for these different tumor clones and minimizes erroneous data contributed by profiling of admixed normal tissues. The method provides the advantages of obtaining useful information regarding biomarkers predictive of tumor genomic clonotypes responsive to a particular therapy and allows for the elucidation of combined treatments which would be efficacious for treating multiple tumor clones that comprise patients' tumors. Overall, this method permits identification of biomarkers predictive of treatment efficacy for different tumor clones enabling more precise determination of the key efficacy biomarkers for application in clinical trials as depicted in FIG. 12.

In the clonal responder genomics approach, tumor tissue samples are first separated into distinct normal and tumor cell clonal populations by flow cytometry and subjected to genomics and proteomics analyses. Flow cytometry techniques including light scatter, fluorescence antibodies staining, and fluorescent DNA binding propidium iodine staining 4,6-diamidino-2-phenylindole (DAPI) are known in the art and are utilized to separate fresh or paraffin embedded tissue samples into clonal populations (see Hedley D W, et al. Method for analysis of cellular DNA content of paraffin-embedded pathological material using flow cytometry. J Histochem Cytochem. 1983 Nov. 31 (11):1333-5 and Heiden Tet al., Combined analysis of DNA ploidy, proliferation, and apoptosis in paraffin-embedded cell material by flow cytometry. Lab Invest. 2000 August; 80(8):1207-13. The separated tumor clones are then subjected to one or more genomics and proteomics evaluations as exemplified in FIGS. 3-11 resulting in the determination of biomarker profiles that characterize the different tumor clones. These biomarker profiles are termed tumor genomics clonotypes. The tumor genomics clonotypes are characterized by their gene expression profiles, copy number variations, single nucleotide polymorphisms, gene mutations, ploidy, cell cycle phase etc depending upon the genomics, proteomics, and flow cytometry evaluations that are performed on the separated tumor clones.

In a preferred embodiment, tumor clonotypes are compared before and after treatment by a method termed tumor genomics clonotype response assessment to identify the biomarker profiles of tumor clones associated with treatment efficacy. This approach permits determination of treatment responses at the molecular and cellular levels providing additional information to guide drug development compared to more crude conventional methods that measure tumor responses only by physical examination, x-rays, computerized tomography, magnetic resonance imaging, positron emission tomography and other methods known in the art. In tumor genomics clonotype response assessments, the biomarker profiles of tumor clones associated with treatment efficacy are determined by comparing the characteristics of tumor genomics clonotypes before and after therapy. Tumor genomics clonotypes that are present pre-treatment and that are either absent or reduced in proportion following therapy are considered responsive to that treatment. In addition, tumor clonotypes that acquire increased expression of genes associated with apoptosis, cell cycle arrest or cellular senescence following treatment are also considered responsive to treatment. Increased expression of these molecular tumor response markers in the post treatment tumor clonotypes compared to the pre-treatment clonotypes is determined by either immunocytofluorimetry or by gene expression profiling. Examples of gene expression associated with the processes of apoptosis (caspase 3), cell cycle arrest (p21) and cellular senescence (senescence-associated-b-galactosidase, p16^{INK4a}, DcR2, p15^{INK4b}) may be utilized for these determinations as well as other genetic markers of these processes that are known in the art (see Campo-Trapero J, et al., Cellular senescence in oral cancer and precancer and treatment implications: a review. Acta Oncol. 2008; 47(8):1464-74 and Senzer N et al., p53 therapy in a patient with Li-Fraumeni syndrome. Mol Cancer Ther. 2007 May 6 (5):1478-82. The tumor genomics profiles of clones responsive to a particular treatment are then compared by bioinformatics software like Go Gene Metacor (see http://www.genego.com/metacore.php) to identify molecular pathways shared by responding tumor clonotypes which are predictive biomarkers of efficacy.

In an analogous fashion, tumor clonotypes that do not respond to treatment are similarly identified. These treatment resistant tumor clonotypes are not diminished by the specific treatment and do not exhibit increased expression of the genes associated with apoptosis, cell cycle arrest or cellular senescence. The tumor genomics profiles of treatment resistant clones can then be compared by bioinformatics software like Go Gene Metacor (see http://www.genego.com/metacore.php) to identify molecular pathways shared by non-responding tumor clonotypes which are predictive biomarkers of treatment resistance.

Tumor genomics clonotypes responsive and resistant to treatment are integrated to define the biomarkers predictive of that treatment's efficacy. The biomarkers predictive of treatment efficacy will include those tumor genomics profiles associated with tumor clonotype treatment response and exclude profiles associated with tumor clonotype treatment resistance. These biomarker marker profiles of efficacy are then employed in either conventional clinical trial designs or in the methods of multiplexed continuous biomarker clinical trials and tandem independent biomarker clinical trials.

The assessment of tumor genomics clonotype responses has several advantages compared to conventional methods for determining tumor responses to treatment. Useful information regarding the efficacy of a specific treatment for a particular tumor genomic clonotype may be identified at the molecular and cellular level which would not be appreciated by conventional radiographic and imaging response assessments. This will be particularly true when the induction of senescence is the predominant treatment response or when the responsive clonotype represents a small population of the patient's tumor that may not result in tumor size reductions assessed by conventional methods. This information has significant utility because it identifies the clonotypes responsive to a specific treatment which may then exhibit more readily apparent clinical effects in tumors where the responsive clone represents a larger proportion of the tumor. Furthermore, it will be appreciated by one skilled in the art that curative therapy will require effective treatment for all tumor clones that are present in a patient and that populations comprising a small proportion of a tumor at one point in time will eventually become a larger portion of a tumor when more abundant clones are eradicated by other therapies. In this regard, a database of tumor clonotypes responsive and resistant to specific treatments is generated to guide future patient therapies and clinical trial designs.

With respect to the conduct of multiplexed continuous biomarker clinical trials and tandem independent biomarker clinical trials, the integrated clonotypes responsive and resistant to therapy are utilized as biomarkers predictive of efficacy that may be utilized and refined as shown in FIGS. 1 and 2. An iterative process of assessing the responsive and resistant tumor clonotypes will identify the shared biomarkers predictive of efficacy for several clonotypes that are most useful for identifying patients most likely to benefit from the experimental therapy compared to the control treatment. In this regard, experimental treatment of patient subpopulations with tumors having large proportions of clonotypes demonstrating responsiveness to the experimental therapy and resistance to the standard control treatment are most likely to produce a positive clinical trial outcome.

Ideally, all patients in a clinical trial will be tumor clonotyped before and after treatment to improve the definitions of the predictive biomarkers of efficacy and to increase the database of responsive and resistant tumor clones for future application in guiding patient treatment and clinical trials designs. However, additional embodiments permit clonal responder genomics to identify biomarkers predictive of treatment efficacy without the need to evaluate all treated patients before and after therapy. In this regard, to conserve resources and to focus assessments upon potentially more relevant tumor clonotypes, clonal responder genomics analysis are performed on those patients demonstrating responses to treatment by conventional means including physical examination, x-rays, computerized tomography, magnetic resonance imaging, positron emission tomography and other assessments known in the art. This will identify tumor responsive clonotypes and their associated biomarker profiles predictive of efficacy to improve clinical trial outcomes.

In another cost saving embodiment, the tumor clonotypes are just determined on pre-treatment samples. Predictive biomarkers of efficacy are then identified by correlating the predominant tumor clonotypes with clinical outcomes associated with treatment efficacy parameters known in the art e.g. tumor responses, time to tumor progression, progression free survival and overall survival.

Each of the methods of identification of biomarkers predictive of efficacy described herein has the advantage and practical utility of averting the ethical dilemma of confirmatory clinical trial designs containing treatment arms unlikely to be efficacious which can occur with conventional clinical trials methods. For example, the methods of multiplexed continuous biomarker clinical trials and tandem independent biomarker clinical trials permit real time adjustment of clinical trial subpopulations for evaluation of efficacy and automatically alert investigators when a statistically significant result documenting efficacy for a particular biomarker defined subpopulation is defined compared to the treatment control. This contrasts with conventional clinical trial designs where subpopulations not predicted prior to trial initiation are discovered only by post hoc analyses which must then be confirmed in a subsequent clinical study. This is problematic ethically as confirmation of the findings will subject future patient subpopulations to knowingly receive the previously demonstrated inferior therapy. The methods of multiplexed continuous biomarker clinical trials and tandem independent biomarker clinical trials obviate this dilemma. In this regard, these methods utilize all available clinical trial data including results from patients obtained prior to the discovery of potentially useful biomarker profiles and limits subsequent treatment to the minimum number of additional patients required to demonstrate statistically significant efficacy. This results in the cessation of patient treatment with ineffective therapies at the earliest possible moment and limits unnecessary exposure of patients to less effective treatments. Conventional clinical trial methods are woefully inadequate in this regard and result in numerous patients being treated with ineffective therapies before the trials are completed or confirmed.

It will also be recognized by those skilled in the art of drug development that the methods of multiplexed continuous biomarker clinical trials and tandem independent biomarker clinical trials with interim analyses to validate biomarkers predictive of efficacy may be utilized for the development of drugs to treat a broad range of diseases and is particularly well suited for the development of prophylactic agents that require large control populations.

To permit acceptance by regulatory agencies for drug marketing approval, the multiplexed continuous biomarker clinical trials for cancer therapies should employ generally accepted efficacy evaluations such as overall survival, time to progression, progression free survival and tumor response rates. In addition, the sample size should be sufficient to ensure random allocation to study arms for factors that were not used as stratification variables for randomization and the tumor tissue should be obtained and evaluated in the vast majority of the registered and randomized study subjects. The biomarker assay methodology should be reviewed by the regulatory agencies and determined they have acceptable analytical performance characteristics (e.g., sensitivity, specificity, accuracy, precision) prior to assay performance on test samples. The biomarker testing should be performed by individuals who are masked to treatment assignment and the clinical outcome results.

Examples of the genomics technologies that may be utilized to identify predictive biomarkers for application in multiplexed continuous and/or tandem independent clinical trials are described in FIGS. 3-12. These and related genomics and proteomics methods will generate literally billions of potential predictive biomarkers. Various aspects of the above methods may be implemented automatically or semi-automatically using a computer system. This automated element of the embodiment decreases the time required to identify treatment efficacy in biomarker defined populations. The biomarker analyses predictive of drug efficacy are performed in real time and are continuously performed whenever patients' clinical data from the trials are updated. Criteria defined with regulatory agencies are used to set parameters for numbers of patients, clinical endpoints, and statistical significance of biomarker correlation with treatment efficacy to automatically trigger an alert that sufficient efficacy has been demonstrated to warrant regulatory submissions for approval consideration. This will accelerate drug approvals compared to current methods that review data a discrete time points rather than the continuous methods of the described herein. Components typically incorporated in at least some of the computer systems and other devices for use with the present method may include one or more central processing units (“CPUs”) for executing computer programs; a computer memory for storing programs and data while they are being used; a persistent storage device, such as a hard drive for persistently storing programs and data; a computer-readable media drive, such as a CD-ROM drive, for reading programs and data stored on a computer-readable medium; and a network connection for connecting the computer system to other computer systems, such as via the Internet. While computer systems configured as described above are typically used to support the operation method, those skilled in the art will appreciate that the method may be implemented using devices of various types and configurations, and having various components.

### REFERENCES

1. Christopher P. Adams and Van V. Brantner, Estimating the Cost of New Drug Development: Is it Really $802 Million?, Health Affairs, vol. 25, no. 2 at 420-28 (2006) (doi: 10.1377/hlthaff.25.2.420).

2. World Health Organization, Cancer, http://www.who.int/cancer/en/(last visited Feb. 27, 2009).

3. Cancer.Net, Phases of Clinical Trials, http://www.cancer.net/patient/Diagnosis +and+Treatment/Treating+Cancer/Clinical+Trials/Phases+of+Clinical+Trials (last visited Feb. 27, 2009).

4. Illumina, http://www.illumina.com/pages.ilmn?ID=176

5. Affymetrix, http://www.affymetrix.com/index.affx.

6. Voelkerding K V, Dames S A, Durtschi J D. Next-Generation Sequencing: From Basic Research to Diagnostics Clin Chem. 2009 Feb 26. [Epub ahead of print].

7. Marioni J C, Mason C E, Mane S M, Stephens M, and Gilad Y: RNA-seq: An assessment of technical reproducibility and comparison with gene expression arrays. Genome Res. 2008 Sep. 18 (9): 1509-1517.

8. Ma Y, Ding Z, Qian Y, Shi X, Castranova V, Harner E J, Guo L. Predicting cancer drug response by proteomic profiling. Clin Cancer Res. 2006 Aug. 1; 12(15):4583-9.

9. Ma Y, Ding Z, Qian Y, Wan Y W, Tosun K, Shi X, Castranova V, Harner E J, Guo NL. An integrative genomic and proteomic approach to chemosensitivity prediction. Int J Oncol. 2009 January; 34(1):107-15.

10. Jose Baselga et al., Phase II Genomics Study of Ixabepilone as Neoadjuvant Treatment for Breast Cancer, J. Clin. Oncol., Vol. 27, No. 4 at 526-34 (Feb. 1, 2009), (Epub Dec. 15, 2008).

11. Ryan D. Morin, Matthew Bainbridge, Anthony Fejes, Martin Hirst, Martin Krzywinski, Trevor J. Pugh, Helen McDonald, Richard Varhol, Steven J. M. Jones, and Marco A. Marra: Profiling the HeLa S3 transcriptome using randomly primed cDNA and massively parallel short-read sequencing. BioTechniques 2008 45:81-94

12. Zhao Q, Caballero O L, Levy S, Stevenson B J, Iseli C, de Souza S J, Galante P A, Busam D, Leversha M A, Chadalavada K, Rogers Y H, Venter J C, Simpson A J, Strausberg R L. Transcriptome-guided characterization of genomic rearrangements in a breast cancer cell line. Proc Natl Acad Sci U S A. 2009 Feb. 10; 106(6):1886-91. Epub 2009 Jan. 30.

13. Ley T J, Mardis E R, Ding L, Fulton B, McLellan M D, et al. (2008) DNA sequencing of a cytogenetically normal acute myeloid leukaemia genome. Nature 456:66-72.

14. Mega J L, Close S L, Wiviott S D, Shen L, Hockett R D, Brandt J T, Walker J R, Antman E M, Macias W, Braunwald E, Sabatine M S. Cytochrome p-450 polymorphisms and response to clopidogrel. N Engl J Med. 2009 Jan. 22; 360(4):354-62. Epub 2008 Dec. 22.

15. DeWitte A et al., 60-mer Oligo-Based Comparative Genomic Hybridization Application Note. http://www.chem.agilent.com/Library/applications/CGH_ApplicationNote_5989-4530EN_72dpi(RGB).pdf accessed Jun. 2, 2009

16. Hedley D W, Friedlander M L, Taylor I W, Rugg C A, Musgrove E A. Method for analysis of cellular DNA content of paraffin-embedded pathological material using flow cytometry. J Histochem Cytochem. 1983 Nov. 31 (11):1333-5.

17. Heiden T, Castaños-Vëlez E, Andersson LC, Biberfeld P. Combined analysis of DNA ploidy, proliferation, and apoptosis in paraffin-embedded cell material by flow cytometry. Lab Invest. 2000 August; 80(8):1207-13.

18. Campo-Trapero J, Cano-Sänchez J, Palacios-Sänchez B, Llamas-Martinez S, Lo Muzio L, Bascones-Martinez A. Cellular senescence in oral cancer and precancer and treatment implications: a review. Acta Oncol. 2008; 47(8):1464-74.

19. Senzer N, Nemunaitis J, Nemunaitis M, Lamont J, Gore M, Gabra H, Eeles R, Sodha N, Lynch F J, Zumstein L A, Menander K B, Sobol R E, Chada S. p53 therapy in a patient with Li-Fraumeni syndrome. Mol Cancer Ther. 2007 May 6 (5):1478-82.

1. A method for a multiplexed continuous biomarker clinical trial that evaluates multiple drugs concurrently or subsequently against a continuously collected and enlarging control group with increasing statistical power, the method comprising:
testing concurrently or subsequently multiple drugs Xₙ with predictive efficacy biomarker profiles Yₙ against a continuously collected control group of patients that are found to have the predictive biomarker profiles Yₙ but are treated with the standard of care without the drugs Xₙ; performing interim analysis to determine the efficacy results of drugs Xₙ compared to the first control group of patients that are found to have the predictive biomarker profiles Yₙ but are treated with the standard of care without the drugs Xₙ, wherein if the efficacy results of the drugs Xₙ compared to the first control group with predictive efficacy biomarker profiles Yₙ are positive, presenting the drugs Xₙ for regulatory approval, or testing additional patients if required to demonstrate statistically significant differences in treatment outcome benefiting the patients treated with drugs Xₙ compared to the first control group of patients with biomarker profiles Yₙ

2. The method of claim 1, wherein if the interim results for a specific drug Xₙ with predictive efficacy biomarker profile Yₙ is not positive then identifying a second predictive biomarker profile from the interim analysis of biomarkers Yₙ that does predict the efficacy of drug Xₙ to demonstrate statistically significant differences in treatment outcome benefiting the patients treated with drugs Xₙ compared to the second control group of patients with biomarker profiles Yₙ.

3. The method for a multiplexed continuous biomarker clinical trial of claim 1 further comprising performing at least two independent clinical studies, either concurrently or subsequently, to increase statistical rigor and decrease chances of false positive association of biomarker profiles with treatment efficacy, wherein the at least two independent clinical studies are substantially the same and until the at least two independent clinical studies produce substantially the same beneficial clinical results.

4. The method of claim 1, wherein the method is implemented with the use of a computer system.

5. The method of claim 2, wherein the method is implemented with the use of a computer system.

6. The method of claim 3, wherein the method is implemented with the use of a computer system.

7. A method in a computer system for conducting a clinical trial that is semi-continuous and allows for the testing of multiple drugs in parallel, the method comprising:
determining a panel of static, dynamic or differential biomarkers that may be predictive of treatment efficacy for a selected group of patients;
identifying drugs D₁ to Dₙ, where n is greater than 1, having predictive efficacy for patients having biomarker profile BPₙ;
receiving testing results for drug Dₙ in a group of patients Gₙ having biomarker profile BPₙ against a control group of patients having biomarker profile BPₙ but are treated with the standard of care without drug Dₙ;
determining the efficacy of drug Dₙ in the group of patients Gₙ compared to the control group of patients, wherein if the efficacy results of the drug Dₙ compared to the control group of patients is negative, identifying a subset of the group of patients Gₙ having biomarker profile BPₓ, where the efficacy results of the drug Dₙ in the group of patients Gₓ compared to the control group of patients is positive.

8. The method of claim 7 wherein the steps of determining a panel of static, dynamic or differential biomarkers, receiving testing results for drug Dₙ in a group of patients Gₙ, and determining the efficacy of drug Dₙ in the group of patients Gₙ are in a real time and continuous manner.

9. The method of claim 1 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

10. The method of claim 2 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

11. The method of claim 3 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

12. The method of claim 4 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

13. The method of claim 5 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

14. The method of claim 6 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

15. The method of claim 7 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.

16. The method of claim 8 where the biomarker profiles of a treatment's efficacy are determined by tumor responder clonotype genomics comprising the steps of:
a) isolating tumor clones by flow cytometry;
b) determining the genomics and proteomics biomarkers of the tumor clones;
c) categorization of tumor clones as treatment sensitive or resistant by assessments of apoptosis/senescence markers; clinical tumor response; time to progression; progression free survival; or overall survival; and
d) identifying biomarkers predictive of efficacy that are associated with tumor genomic clonotypes sensitive to treatment and are not associated with tumor genomic clonotypes resistant to that treatment.
